(19) United States
(12) Patent Application Publication
(10) Pub. No.: US 2009/0314833 A1
(43) Pub. Date: Dec. 24, 2009

(54) Ticket examining apparatus and ticket examining method

(75) Inventor: Jordi Agud Ruiz, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kanagawa (JP)

(21) Appl. No.: 12/382,911

(22) Filed: Mar. 26, 2009

(30) Foreign Application Priority Data
Jun. 23, 2008 (JP) 2008-163792

(51) Int. Cl. G06K 7/00; G06K 5/00

(52) U.S. Cl. 235/382

(57) ABSTRACT

A ticket examining apparatus includes a transmitting and receiving direction switching unit that switches a transmitting and receiving direction of a signal to be transmitted and received by an antenna, provided within a gate, either toward an entrance direction or an exit direction where a user arrives, and a pass permission determining unit that determines whether to permit the user to pass through the gate, by wirelessly communicating with a portable apparatus of the user using a signal transmitted and received by the antenna and switchably directed by the transmitting and receiving direction switching unit toward one of the entrance direction and the exit direction.

### CROSS-REFERENCE TO RELATED APPLICATION(S)

This application is based upon and claims the benefit of priority of the prior Japanese Patent Application No. 2008-163792, filed on Jun. 23, 2008, the entire contents of which are incorporated herein by reference.

### FIELD

The embodiments discussed herein are directed to a technology that enables ticket examination only by letting a user pass through a ticket gate at stations, recreational facilities, and the like.

### BACKGROUND

In recent years, users of railroad services can pay a fare by using a card on which electronic money is charged (hereinafter, “electronic money card”), without buying a ticket. The users can easily enter or exit a station only by touching a predetermined portion of a ticket gate with an electronic money card.

To touch a predetermined portion with an electronic money card, a user needs to find where the user keeps the electronic money card. Users who are carrying baggage with their both hands and those who have physical disabilities, for example, may have difficulty in touching a predetermined portion with their electronic money cards.

For these reasons, a technology is essential that enables ticket examination only by letting a user pass through a ticket gate without touching a predetermined portion with an electronic money card. For example, Japanese Laid-open Patent Publication No. 2005-69861 discloses a technology for reading and writing data from and to a wireless tag carried by a person or the like passing a gate. Applied to a ticket gate, i.e., a ticket examining apparatus, this technology enables ticket examination only by letting a user pass through a gate.

When plural gates are provided next to each other, however, an electric wave emitted from an antenna of one gate may reach other gates. Then, the gate may, by mistake, read data on a wireless tag carried by a person or the like passing through the other gates. Thus, interference occurs between the gates. In Japanese Laid-open Patent Publication No. 2005-69861, plural antennas are used, and a wireless tag is read only when the wireless tag is detected by the antennas. To apply the technology described in Japanese Laid-open Patent Publication No. 2005-69861 to a ticket examining apparatus, many antennas are used. This causes problems such as complexity of the apparatus and cost increase.

### SUMMARY

According to one aspect of the present invention, a ticket examining apparatus includes a transmitting and receiving direction switching unit that switches a transmitting and receiving direction of a signal to be transmitted and received by an antenna, provided within a gate, either toward an entrance direction or an exit direction where a user arrives, and a pass permission determining unit that determines whether to permit the user to pass through the gate, by wirelessly communicating with a portable apparatus of the user using a signal transmitted and received by the antenna and switchably directed by the transmitting and receiving direction switching unit toward one of the entrance direction and the exit direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic of automatic ticket examining apparatuses each having a function of a BAN access point according to an embodiment of the present invention;

FIG. 2 is a schematic of a beam pattern emitted from an adaptive array antenna toward an entrance direction;

FIG. 3 is a schematic of a beam pattern emitted from the adaptive array antenna toward an exit direction;

FIG. 4 is a functional block diagram of the BAN access point depicted in FIG. 1;

FIG. 5 is a functional block diagram of a BAN terminal depicted in FIG. 1;

FIG. 6 is a flowchart of a procedure of automatic ticket examination processing performed by the BAN access point when a passenger arrives at an entrance;

FIG. 7 is a flowchart of a procedure of automatic ticket examination processing performed by the BAN access point when a passenger arrives at an exit;

FIG. 8 is a schematic of automatic ticket examining apparatuses each including an adaptive array antenna on a side surface thereof;

FIG. 9 is a schematic of a beam pattern emitted from the adaptive array antenna toward an entrance direction;

FIG. 10 is a schematic of a beam pattern emitted from the adaptive array antenna toward an exit direction;

FIGS. 11A and 11B are schematics of automatic ticket examining apparatuses including no passenger detection sensor; and

FIG. 12 is a flowchart of a procedure of a passenger detection process using no passenger detection sensor.

### DESCRIPTION OF EMBODIMENTS

Exemplary embodiments of a ticket examining apparatus and a ticket examining method according to the present invention are described in detail below with reference to the accompanying drawings.

The following describes an overview of an automatic ticket examination according to an embodiment of the present invention. In the automatic ticket examination according to the present embodiment, a portable telephone and a body area network (BAN) access point are employed. The portable telephone includes a built-in BAN terminal which includes a BAN communication device and an electronic money card. The BAN access point is installed in a gate. Because the BAN terminal is built in the portable telephone, a passenger need not use any special device for ticket examination.

When a passenger arrives at the gate, very short distance wireless communication is automatically performed between the BAN terminal and the BAN access point. By performing wireless communication using a BAN, interference between gates is prevented. Further, the wireless communication using the BAN can lower the amount of electric power necessary for communication and reduce the risk of data leakage from the electronic money card.

The BAN access point includes two passenger detection sensors and an adaptive array antenna. Two passenger detection sensors are respectively provided at the ends of the gate, and the adaptive array antenna is provided either on the ground at a center part of the gate or on one side surface of the gate. The adaptive array antenna emits a beam pattern toward the direction where the passenger arrives so as to access the information on the electronic money card.

A passenger arrives either from the outside of a station (entrance side) or the inside of the station (exit side). Thus, the adaptive array antenna switches the beam pattern based on the position of the passenger at the gate. Arrival of the passenger is detected by either of the passenger detection sensors.

When a passenger arrives at the entrance of the station, the BAN access point checks whether the balance on the electronic money card is sufficient for the minimum fare, by performing wireless communication using the BAN. Because the passenger moves inside the gate, the BAN access point switches the beam pattern of the adaptive array antenna from the entrance direction to the central direction to provide good communication, as necessary.

When a passenger arrives at the exit of the station, the BAN access point calculates the fare from the boarding station to the alighting station, and deducts the calculated fare from the electronic money card when the electronic money card holds sufficient amount. To ensure the security, information on the electronic money card is encrypted at the portable telephone and decrypted at the BAN access point. Such encryption is particularly important when a credit card number and the like is transmitted from the portable telephone to the BAN access point. At the exit as well as the entrance, the beam pattern of adaptive array antenna is switched from the exit direction to the central direction, as necessary.

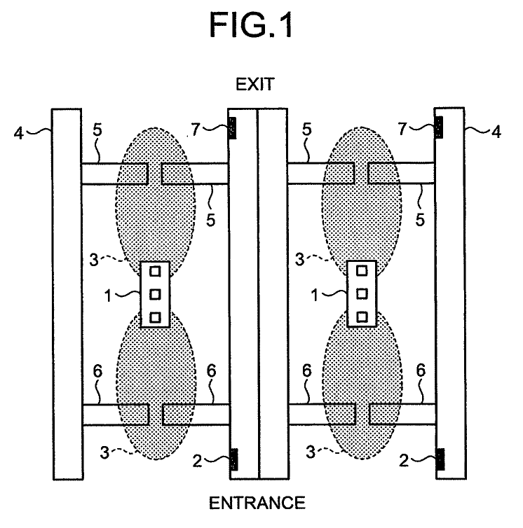

The following describes a structure of an automatic ticket examining apparatus having a function of the BAN access point. FIG. 1 is a schematic of automatic ticket examining apparatuses each including a BAN access point according to the present embodiment. In FIG. 1, two automatic ticket examining apparatuses are provided next to each other.

As depicted in FIG. 1, in the automatic ticket examining apparatus according to the present embodiment, an adaptive array antenna 1 is provided on the ground at a central part of each gate. The adaptive array antenna 1 emits a beam pattern 3 toward the direction where a passenger arrives. Because the adaptive array antenna 1 is provided on the ground, the beam pattern 3 is emitted toward the ceiling. This prevents the radio wave from reaching a neighboring gate, i.e., prevents interference between gates. Side surfaces of an automatic ticket examining apparatus main body 4 are made of metal, and also prevent the radio wave from reaching a neighboring gate.

By providing the adaptive array antenna 1 on the ground, the distance between a portable telephone and a BAN access point can be made short compared with providing the adaptive array antenna 1 on the ceiling. This enables to suppress the electric power necessary for the communication. Considering that the portable telephone operates by battery, suppressing the electric power is important. Moreover, by shortening the distance between the portable telephone and the BAN access point, the risk of information leakage can be lowered.

To detect arrival of a passenger, a passenger detection sensor 2 and a passenger detection sensor 7 are provided at the entrance and the exit of each gate, respectively. When no passenger is detected, entrance doors 6 and exit doors 5 are both kept closed.

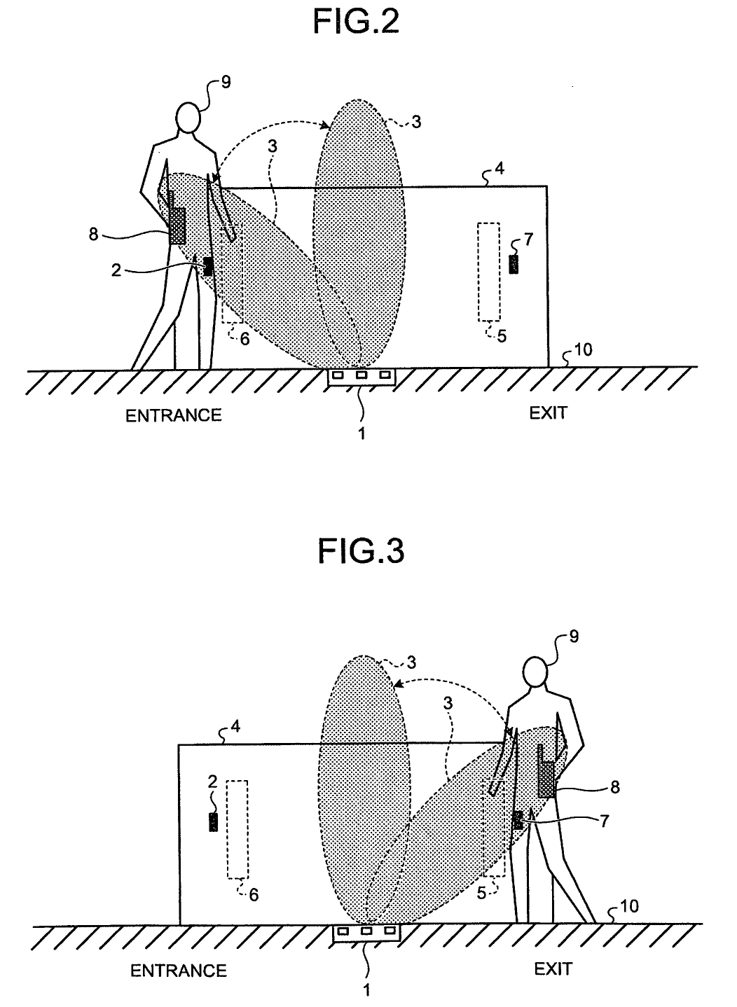

FIG. 2 is a schematic of the beam pattern 3 emitted from the adaptive array antenna 1 toward the entrance direction. FIG. 3 is a schematic of the beam pattern 3 emitted from the adaptive array antenna 1 toward the exit direction. As depicted in FIG. 2, when a passenger 9 carrying a portable telephone 8 arrives at the entrance, the passenger detection sensor 2 detects the passenger, and then the adaptive array antenna 1 provided on ground 10 emits the beam pattern 3 toward the entrance direction. When the passenger 9 moves toward the exit inside the gate, the adaptive array antenna 1 switches the emission direction of the beam pattern 3 toward the central direction.

On the other hand, as depicted in FIG. 3, when the passenger 9 carrying the portable telephone 8 arrives at the exit, the passenger detection sensor 7 detects the passenger, and then the adaptive array antenna 1 provided on the ground 10 emits the beam pattern 3 toward the exit direction. When the passenger 9 moves toward the entrance inside the gate, the adaptive array antenna 1 switches the emission direction of the beam pattern 3 toward the central direction.

In this way, the adaptive array antenna 1 switches the emission direction of the beam pattern 3 from the entrance direction or the exit direction toward the central direction according to the movement of the passenger 9. Thus, good communication is maintained between the BAN terminal of the portable telephone 8 and the BAN access point.

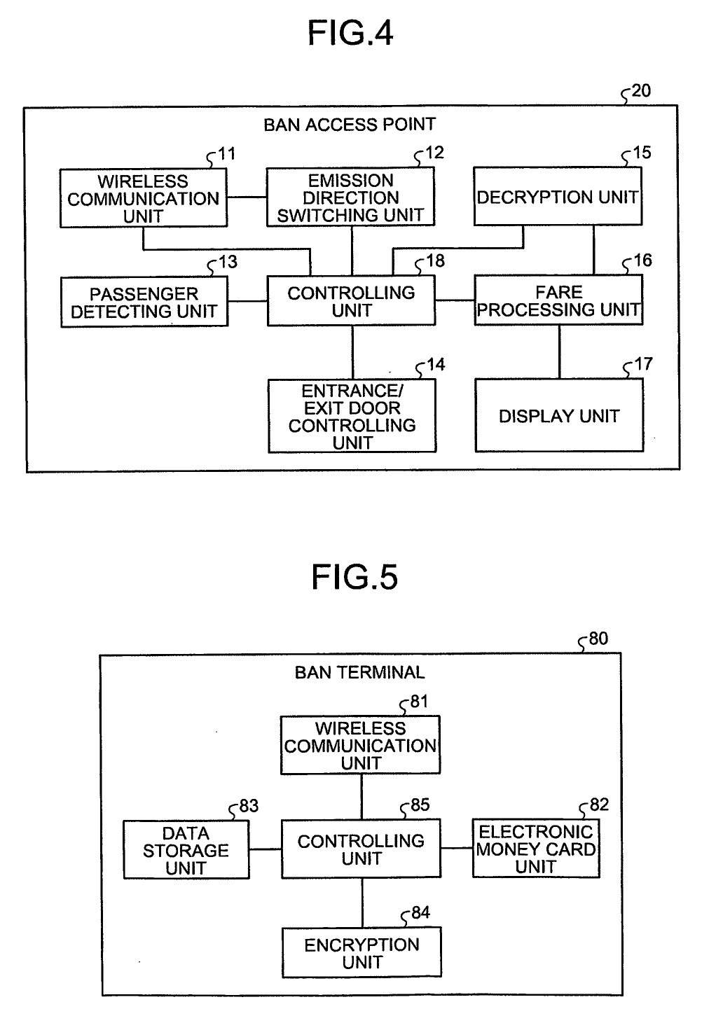

The following describes a functional configuration of the BAN access point. FIG. 4 is a functional block diagram of the BAN access point. As depicted in FIG. 4, a BAN access point 20 includes a wireless communication unit 11, an emission direction switching unit 12, a passenger detecting unit 13, an entrance/exit door controlling unit 14, a decryption unit 15, a fare processing unit 16, a display unit 17, and a controlling unit 18.

The wireless communication unit 11 is a processing unit that performs wireless communication with the BAN terminal of the portable telephone 8, using the adaptive array antenna 1 and the BAN. The wireless communication unit 11 emits the beam pattern 3 toward the entrance direction, the exit direction, or the central direction. Moreover, the wireless communication unit 11 estimates a received signal strength indication (RSSI) level of a signal received from the BAN terminal, and transmits the estimated result to the emission direction switching unit 12.

The emission direction switching unit 12 is a processing unit that switches the direction of the beam pattern 3 to be emitted from the wireless communication unit 11, toward the entrance direction, the exit direction, or the central direction. The emission direction switching unit 12 switches the emission direction of the beam pattern 3, depending on which of the passenger detection sensors 2 and 7 detects a passenger, or based on the RSSI, i.e., the strength of the signal received by the wireless communication unit 11 from the BAN terminal. The emission direction switching unit 12 switches the emission direction of the beam pattern 3, so that good communication is performed with the BAN terminal, using a single antenna.

The passenger detecting unit 13 is a processing unit that detects arrival of a passenger using the passenger detection sensors 2 and 7. The entrance/exit door controlling unit 14 is a processing unit that controls opening and closing of the entrance doors 6 and the exit doors 5.

The decryption unit 15 is a processing unit that decrypts the information on the electronic money card encrypted and transmitted from the BAN terminal. The decryption unit 15 transmits an encryption code necessary for encryption to the BAN terminal.

The fare processing unit 16 is a processing unit that performs fare processing. The fare processing unit 16 checks the balance transmitted from the BAN terminal, deducts the fare from the balance, and transmits the remaining balance after deduction of the fare to the BAN communication device. The fare processing unit 16 instructs the display unit 17 to display a message, such as the remaining balance after deduction of the fare or an error message. The display unit 17 is a display that displays a message to the passenger.

The controlling unit 18 is a processing unit that controls the entire BAN access point 20. Specifically, by shifting the control among functioning units or receiving and transmitting data, the controlling unit 18 enables the BAN access point 20 to function as one device.

The following describes a functional configuration of the BAN terminal. FIG. 5 is a functional block diagram of the BAN terminal. As depicted in FIG. 5, a BAN terminal 80 includes a wireless communication unit 81, an electronic money card unit 82, a data storage unit 83, an encryption unit 84, and a controlling unit 85.

The wireless communication unit 81 is a processing unit that wirelessly communicates with the BAN access point 20 using the BAN. The electronic money card unit 82 is a storage unit that stores therein information such as the balance of electronic money.

The data storage unit 83 is a storage unit used by the controlling unit 85 to temporally store data. The encryption unit 84 is a processing unit that encrypts, when information on an electronic money card is transmitted to the BAN access point 20, the information on the electronic money card using an encryption code transmitted from the BAN access point 20.

The controlling unit 85 is a processing unit that controls the entire BAN terminal 80. Specifically, the controlling unit 85 shifts the control among functional units or receives and transmits data based on the signal received by the wireless communication unit 81 from the BAN access point 20. In this way, the controlling unit 85 enables the BAN terminal 80 to function as one device.

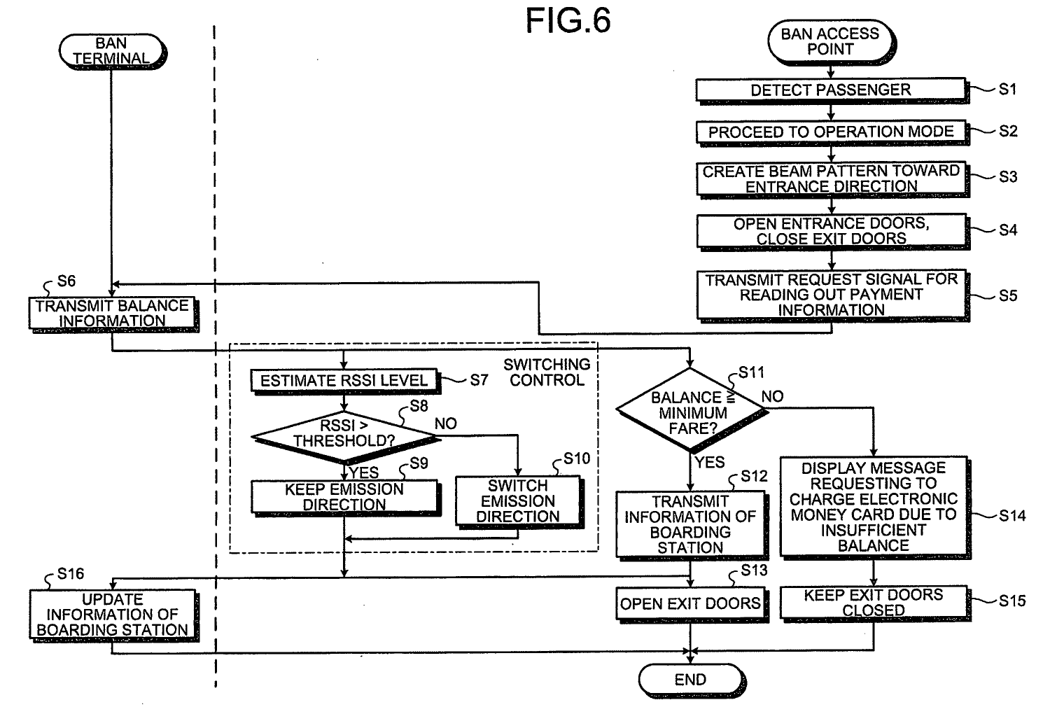

The following describes a procedure of automatic ticket examination processing performed by the BAN access point 20 when the passenger arrives at the entrance. FIG. 6 is a flowchart of a procedure of automatic ticket examination processing performed by the BAN access point 20 when a passenger arrives at the entrance.

As depicted in FIG. 6, in the automatic ticket examination processing, when the passenger detecting unit 13 detects a passenger with the passenger detection sensor 2 (Step S1), the BAN access point 20 proceeds to an operation mode from a standby mode (Step S2). When no passenger is detected, the BAN access point 20 remains in the standby mode for saving electric power.

While the emission direction switching unit 12 creates the beam pattern 3 toward the entrance direction (Step S3), the entrance/exit door controlling unit 14 opens the entrance doors 6 and closes the exit doors 5 so that the passenger may go through the gate path during ticket examination processing (Step S4). The wireless communication unit 11 emits the beam pattern 3 toward the entrance direction and transmits a request signal for reading out payment information (Step S5).

In response to the request signal for reading out payment information, the BAN terminal 80 reads out the balance information from the electronic money card unit 82, and transmits a signal to the BAN access point 20 (Step S6). The wireless communication unit 11 of the BAN access point 20 receives the signal from the BAN terminal 80 and estimates the RSSI level (Step S7).

The emission direction switching unit 12 determines whether the RSSI level is greater than a threshold (Step S8). If the RSSI level is greater than the threshold, the passenger exists within the current range of the beam pattern 3, and therefore the emission direction switching unit 12 keeps the emission direction of the beam pattern 3 (Step S9). On the contrary, if the RSSI level is less than the threshold, the emission direction switching unit 12 determines that the passenger has moved out from the current range of the beam pattern 3, so as to switch the emission direction of the beam pattern 3 to the central direction (Step S10).

The fare processing unit 16 of the BAN access point 20 receives the balance information from the wireless communication unit 11, and determines whether the balance is equal to or more than the minimum fare (Step S11). If the balance is equal to or more than the minimum fare, the passenger can board. Thus, the fare processing unit 16 transmits information of the boarding station to the BAN terminal 80 so that the fare can be calculated at the alighting station (Step S12). The entrance/exit door controlling unit 14 opens the exit doors 5 so that the passenger can enter the station (Step S13).

On the contrary, if the balance is not equal to or more than the minimum fare, the passenger cannot board. Because the balance is not sufficient, the display unit 17 displays a message requesting to charge the electronic money card (Step S14). The entrance/exit door controlling unit 14 keeps the exit doors 5 closed so that the passenger cannot enter the station (Step S15). In the BAN terminal 80, upon receiving the information of the boarding station via the wireless communication unit 81, the controlling unit 85 updates the electronic money card with the received information of the boarding station (Step S16).

In this way, the BAN access point 20 performs wireless communication with the BAN terminal 80 while controlling switching of the beam pattern 3. This enables the automatic ticket examination processing at the time of boarding under a good communication environment.

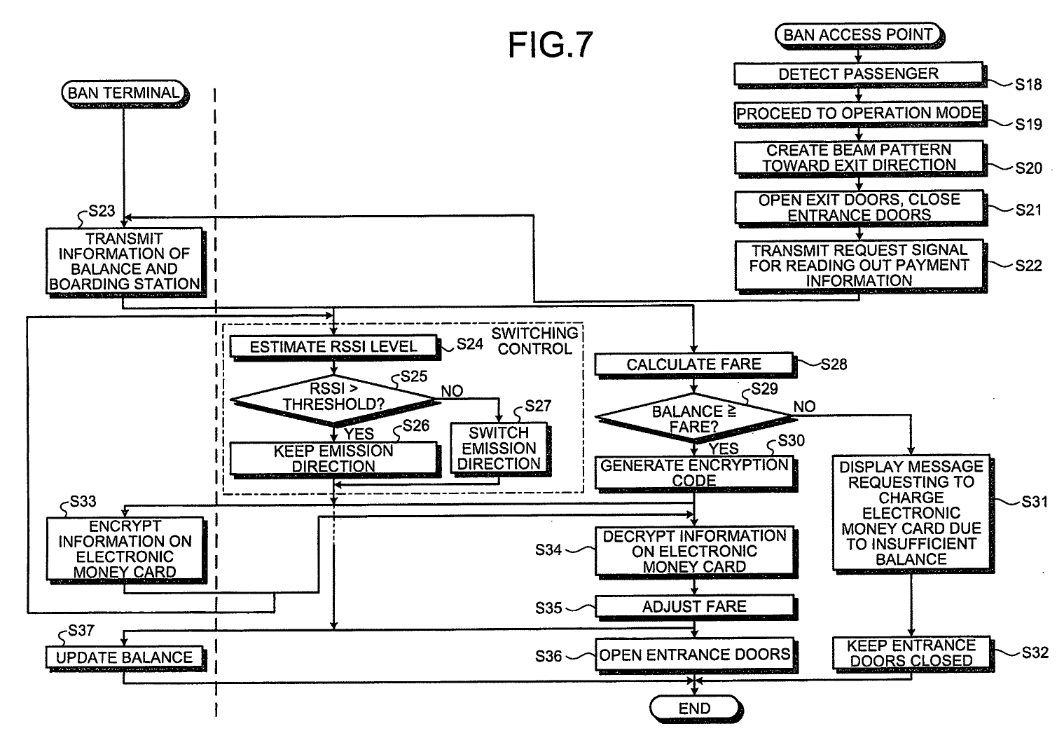

The following describes a procedure of automatic ticket examination processing performed by the BAN access point 20 when a passenger arrives at the exit. FIG. 7 is a flowchart of a procedure of automatic ticket examination processing performed by the BAN access point 20 when a passenger arrives at the exit.

As illustrated in FIG. 7, in the automatic ticket examination processing, when the passenger detecting unit 13 detects a passenger with the passenger detection sensor 7 (Step S18), the BAN access point 20 proceeds to an operation mode from a standby mode (Step S19).

While the emission direction switching unit 12 creates the beam pattern 3 toward the exit direction (Step S20), the entrance/exit door controlling unit 14 opens the exit doors 5 and closes the entrance doors 6 so that the passenger may go through the gate path during ticket examination processing (Step S21). The wireless communication unit 11 emits the beam pattern 3 toward the exit direction and transmits a request signal for reading out payment information (Step S22).

In response to the request signal for reading out the payment information, the BAN terminal 80 reads out the information of the balance and the boarding station from the electronic money card unit 82, and transmits a signal to the BAN access point 20 (Step S23). The wireless communication unit 11 of the BAN access point 20 receives the signal from the BAN terminal 80 and estimates the RSSI level (Step S24).

The emission direction switching unit 12 determines whether the RSSI level is greater than a threshold (Step S25). If the RSSI level is greater than the threshold, the passenger exists within the current range of the beam pattern 3, and therefore the emission direction switching unit 12 keeps the emission direction of the beam pattern 3 (Step S26). On the contrary, if the RSSI level is less than the threshold, the emission direction switching unit 12 determines that the passenger has moved out from the current range of the beam pattern 3, so as to switch the emission direction of the beam pattern 3 (Step S27).

The fare processing unit 16 of the BAN access point 20 receives the information of the balance and the boarding station from the wireless communication unit 11, calculates a fare (Step S28), and determines whether the balance is equal to or more than the minimum fare (Step S29). If the balance is equal to or more than the minimum fare, payment is possible. Thus, the fare processing unit 16 generates an encryption code for encrypting the information (e.g., electronic money information) on the electronic money card (Step S30) and transmits the code to the BAN terminal 80.

The encryption unit 84 of the BAN terminal 80 encrypts the electronic money information using the encryption code (Step S33), and transmits the information to the BAN access point 20. The decryption unit 15 of the BAN access point 20 decrypts the electronic money information (Step S34), adjusts the fare (Step S35), and transmits a payment result to the BAN terminal 80. The controlling unit 85 of the BAN terminal 80 updates the balance of the electronic money card unit 82 (Step S37). The entrance/exit door controlling unit 14 of the BAN access point 20 opens the entrance doors 6 so that the passenger can exit the station (Step S36).

On the contrary, if the balance is not equal to or more than the fare, the balance is not sufficient for the fare. Due to the insufficient balance, the display unit 17 displays a message requesting to charge the electronic money card (Step S31). The entrance/exit door controlling unit 14 keeps the entrance doors 6 closed so that the passenger cannot exit the station (Step S32).

In this way, the BAN access point 20 performs wireless communication with the BAN terminal 80 while controlling switching of the beam pattern 3. This enables the automatic ticket examination processing at the time of alighting under a good communication environment.

As described above, according to the present embodiment, the adaptive array antenna 1 is provided on the ground at a center part of a gate and wireless communication is performed using the BAN. This prevents the interference between gates, realizing wireless communication with less electric power.

According to the present embodiment, the emission direction switching unit 12 switches the direction of the beam pattern 3 to be emitted from the adaptive array antenna 1 to the entrance direction, the central direction, or the exit direction, according to where the passenger arrives or the movement of the passenger. Accordingly, the automatic ticket examination which requires the passenger only to pass through the gate is realized with a single antenna.

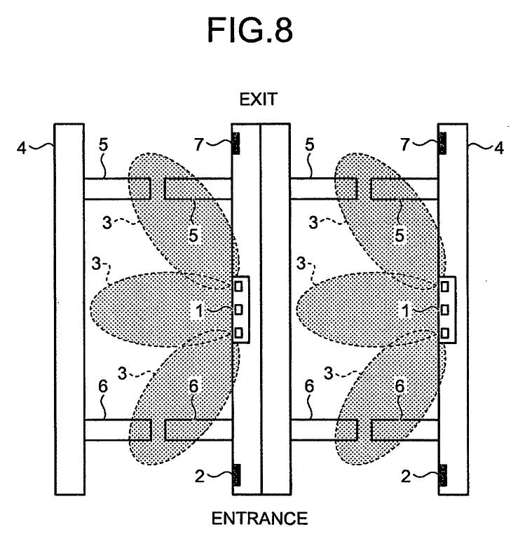

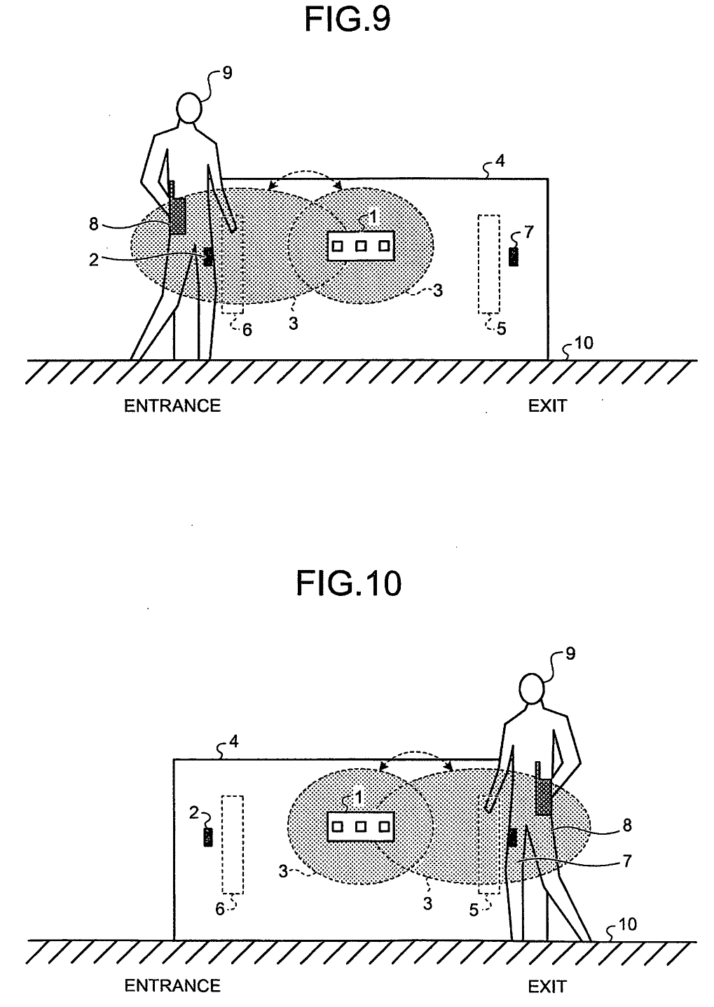

According to the embodiment, the adaptive array antenna 1 is provided on the ground at a center part of a gate. The adaptive array antenna 1 can be provided on a side surface of the automatic ticket examining apparatus. FIG. 8 is a schematic of automatic ticket examining apparatuses each including the adaptive array antenna 1 on a side surface thereof. FIG. 9 is a schematic of the beam pattern 3 emitted from the adaptive array antenna 1 toward the entrance direction. FIG. 10 is a schematic of the beam pattern 3 emitted from the adaptive array antenna 1 toward the exit direction.

As illustrated in FIGS. 8 to 10, the automatic ticket examining apparatus can emit the beam pattern 3 from the side surface thereof, by using the adaptive array antenna 1 provided on the side surface and by switching the emission direction to the entrance direction, the central direction, or the exit direction. As such, providing the adaptive array antenna 1 on the side surface of the automatic ticket examining apparatus also prevents the interference between gates, realizing wireless communication with less electric power.

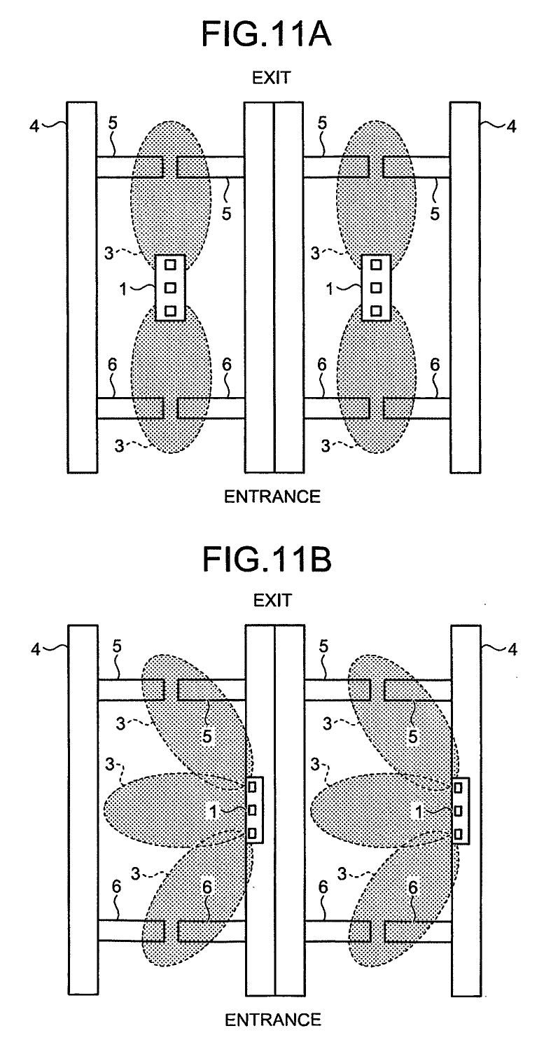

The above describes detection of a passenger using the passenger detection sensors 2 and 7. The passenger may be detected by other means without using the passenger detection sensors 2 and 7. FIGS. 11A and 11B are schematics of automatic ticket examining apparatuses including no passenger detection sensor. FIG. 11A depicts the adaptive array antennas 1 each provided on the ground at each gate, and FIG. 11B depicts the adaptive array antennas 1 provided on one side surfaces of the automatic ticket examining apparatus main body 4.

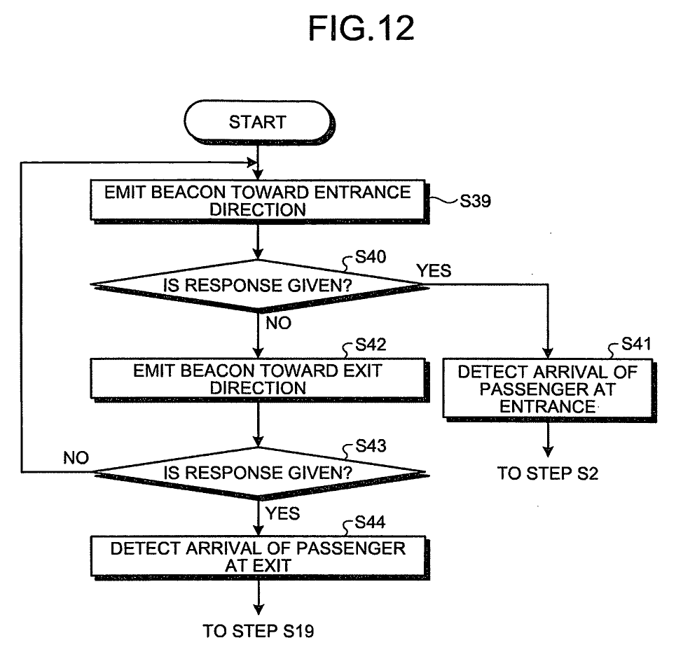

FIG. 12 is a flowchart of a procedure of a passenger detection process using no passenger detection sensor. As depicted in FIG. 12, when using no passenger detection sensor, the BAN access point 20 transmits a beacon to the entrance direction by emitting a beam (Step S39), and determines whether a response is given in a certain period of time (Step S40).

If a response is given, the BAN access point 20 determines that the passenger has arrived at the entrance (Step S41), and the system control goes to Step S2 of FIG. 6. On the contrary, if no response is given, the BAN access point 20 transmits a beacon to the exit direction by emitting a beam (Step S42), and determines whether a response is given in a certain period of time (Step S43).

If a response is given, the BAN access point 20 determines that the passenger has arrived at the exit (Step S44), and the system control goes to Step S19 of FIG. 7. If no response is given, no passenger has arrived at the entrance or the exit. Thus, the system control goes back to Step S39 and continues the process for detecting the arrival of a passenger.

In this way, the BAN access point 20 can detect the arrival of a passenger, without using passenger detection sensors, by transmitting a beacon to the entrance direction and the exit direction and detecting the response from the BAN terminal 80.

In the present embodiment, the emission direction of the beam pattern 3 is switched from the entrance direction or the exit direction to the central direction at one time according to the movement of a passenger inside the gate. The present invention is not limited to this, and the beam pattern 3 may be switched from the entrance direction or the exit direction to the central direction through several steps.

The present embodiment describes the automatic ticket examination at railway stations. The present invention is not limited to this, and is also applicable to a gate that permits a user to enter a specific region or place, or to exit from a specific region or place. Specifically, the present invention is applicable to ticket examining apparatuses provided at bus gates, theaters, concert halls, stadiums, gyms, zoos, and offices.

The information necessary for entering and exiting, however, differs depending on the conditions where the ticket examining apparatuses are provided. For example, information on electronic tickets reserved in advance is required at concert halls, theaters, and stadiums. Information on employee ID numbers is required at offices.

According to one embodiment of the present invention, plural antennas are not required. This provides an advantage of reducing cost of the ticket examining apparatus.

Constituting elements of the present invention, representations, or a given combination of such constituting elements may be applied to a method, an apparatus, a system, a computer program, a recording medium, a data structure, and the like. Such application is effective for solving the problems described earlier.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An apparatus for examining a ticket, the apparatus comprising:
a transmitting and receiving direction switching unit that switches a transmitting and receiving direction of a signal to be transmitted and received by an antenna, provided within a gate, either toward an entrance direction or an exit direction where a user arrives; and
a pass permission determining unit that determines whether to permit the user to pass through the gate, by wirelessly communicating with a portable apparatus of the user using a signal transmitted and received by the antenna and switchably directed by the transmitting and receiving direction switching unit toward one of the entrance direction and the exit direction.

2. The apparatus according to claim 1, wherein the transmitting and receiving direction switching unit switches, according to movement of the user within the gate, a transmitting and receiving direction of the signal from one of the entrance direction and the exit direction to a movement direction of the user.

3. The apparatus according to claim 2, wherein the transmitting and receiving direction switching unit switches the transmitting and receiving direction from one of the entrance direction and the exit direction to a movement direction of the user, when a strength of a received signal is equal to or less than a predetermined threshold.

4. The apparatus according to claim 3, wherein the transmitting and receiving direction switching unit switches the transmitting and receiving direction from one of the entrance direction and the exit direction to a central direction of the gate, when a strength of a received signal is equal to or less than a predetermined threshold.

5. The apparatus according to claim 1, further comprising
a user detecting unit that detects arrival of the user at one of an entrance and an exit, by detecting the portable apparatus using a beacon, and
the transmitting and receiving direction switching unit switches the transmitting and receiving direction to one of the entrance direction and the exit direction where the arrival of the user is detected by the user detecting unit.

6. The apparatus according to claim 1, wherein a body area network (BAN) is used to wirelessly communicate with the portable apparatus.

7. The apparatus according to claim 1, wherein the antenna is provided on ground in the gate.

8. A method for examining a ticket, the method comprising:
switching a transmitting and receiving direction of a signal to be transmitted and received by an antenna, provided within a gate, toward one of an entrance direction and an exit direction where a user arrives; and
determining whether to permit the user to pass through the gate, by wirelessly communicating with a portable apparatus of the user using a signal transmitted and received by the antenna and switchably directed toward one of the entrance direction and the exit direction in the switching.
